(19) United States
(12) Patent Application Publication
(10) Pub. No.: US 2004/0081529 A1
(43) Pub. Date: Apr. 29, 2004

(54) Flexible pin for holding together 2 or more sheets of material or items

(76) Inventors: Russell S. Stanton, Lunenburg, MA (US); Allyn Mackay, Grosse Pointe, MI (US); Edward Daley, Newton, MA (US)

Correspondence Address: Russell S. Stanton, 532 Burrage St, Lunenburg, MA, 01462, US

(21) Appl. No.: 10/324,798

(22) Filed: Apr. 1, 2003

Related U.S. Application Data
(60) Provisional application No. 60/341,414, filed on Dec. 20, 2001.

(51) Int. Cl. F16B 13/06

(52) U.S. Cl. 411/44

(57) ABSTRACT

A locating and/or retaining device comprised of a locking pin 1 a flexible flanged dowel pin 2, a spring 3 and a feature and/or washer 4 for use in a wide array of applications where locating and/or retaining/clamping are required.

### BACKGROUND OF THE INVENTION

This invention relates to a locking flexible flanged dowel pin device. In more detail, the invention relates to an assembly including a flexible flanged barbed and slotted dowel pin, a spring, a feature and/or washer and a locking pin as described above in claim 1, for the purpose of locating and immobilizing material with mating features and thicknesses suitable for capture. The invention also relates to a method of locking two abutting pieces of material together.

A dowel pin is defined in Webster's Third New International Dictionary Unabridged as “a headless smooth or barbed pin usually of circular section fitting into corresponding holes in abutting pieces to act as a temporary fastener or to keep them permanently in their proper relative positions”.

Dowel pins and derivations of such are frequently used in applications where locating and retaining objects is required. An example of such an application might be, but isn't limited to the construction of computer component test fixtures. During testing, computer components are often subjected to extreme conditions which include drastic temperature fluctuations, vibrations and shock loads. The high geometric tolerances and electric conductivity of many computer components make it necessary to temporarily lock or fix such components in place for the duration of a test. Tests are often performed many times on similar parts to ensure reliability of the components, the test and the test equipment. Dowel pins and derivations there of provide reliable reference points for components thus helping to expedite the testing process.

### SUMMARY OF THE INVENTION

One or more abutting pieces of material or components may be retained by passing the flexible flanged dowel pin, barbed end first, through a formed hole in each piece of said material or component the diameter of which is greater than that of the outer diameter of the initial grouping of barbs while compressed, and less than that of the outer diameter of the initial grouping of barbs while not compressed and having a bore less than the distance between the initial and subsequent barbs. One can greatly enhance the clamping ability of said device by inserting and fixing a locking pin to flexible flanged dowel pin.

To release said material or components locking pin must be unfixed and removed from flexible flanged dowel pin. Then an axial and opposing force must be applied to both the flange of the flexible flanged dowel pin and to a feature and/or washer sufficient to compress both the spring and the axial tines allowing the material or component to be removed.

### DETAILED DESCRIPTION OF THE INVENTION

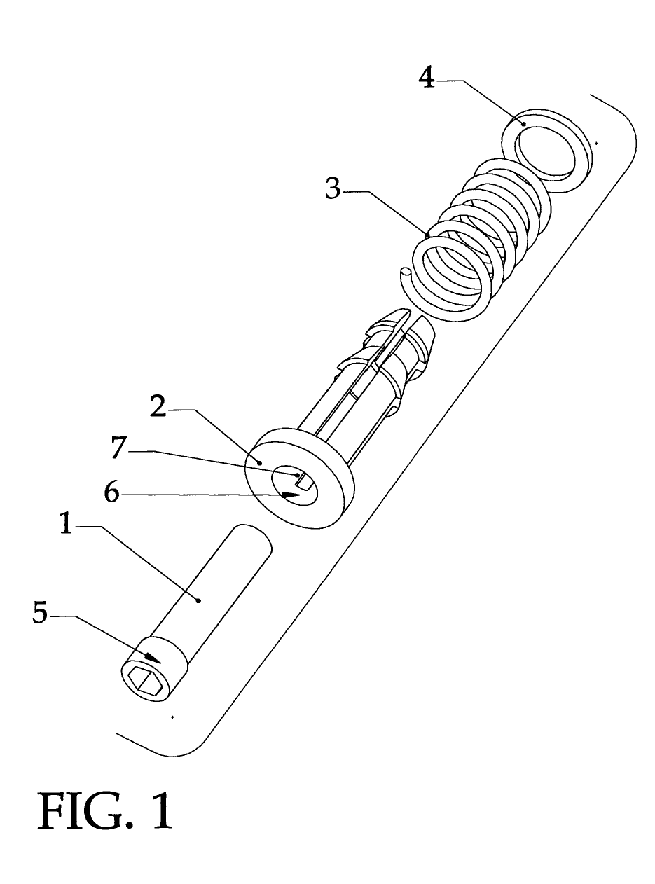

As shown in FIG. 1, an exploded view of the Flexible Flanged Dowel Pin Device where locking pin 1 has a mating feature or thread 5 that allows it to be fixed to flexible flanged dowel pin 2 by means of engaging mating feature or thread 6. Locking pin 1 fits within hole 7, and when inserted prevents tines 8, 9, 10, and 11 from radial flexing inward.

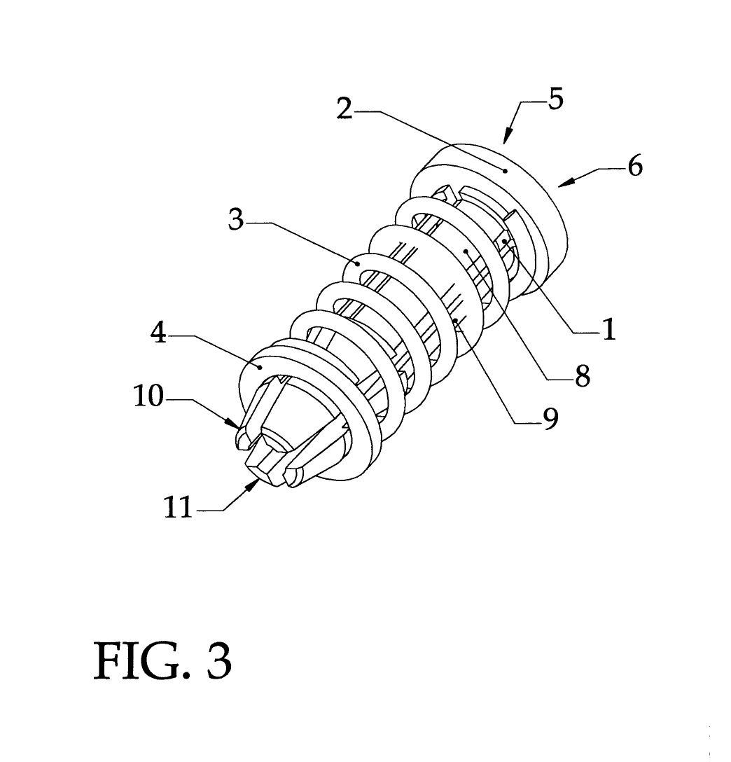

The embodiment shown in FIG. 3 is identical to that shown in FIG. 1 except the parts, locking pin 1, flexible flanged dowel pin 2, spring 3, and feature and/or washer 4 are shown inserted into one another, sharing a common axis and orientation as they would when assembled and in locked state. Spring 3 exerts a force between a feature and or washer 4 and flexible flanged dowel pin device.

Locking pin 1 prevents inward radial movement of tines 8, 9, 10, and 11.

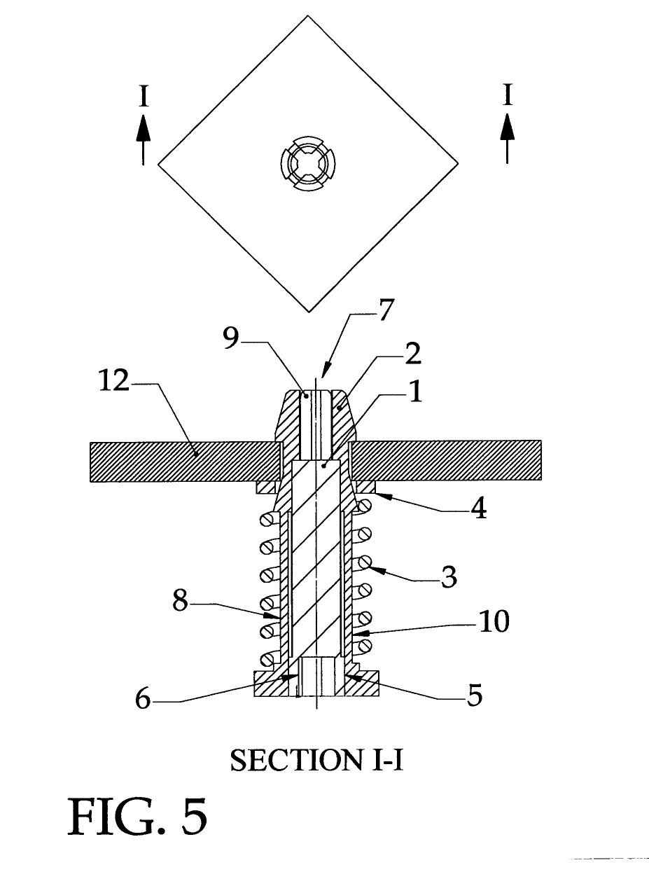

The embodiment shown in FIG. 5 is identical to that shown in FIG. 1 except the parts are shown assembled where spring 3 is compressed and exerting a clamping force between flexible flanged dowel pin 1 and material or component 12.

FIG. 1 is an exploded perspective view of the Flexible Flanged Dowel Pin Device.

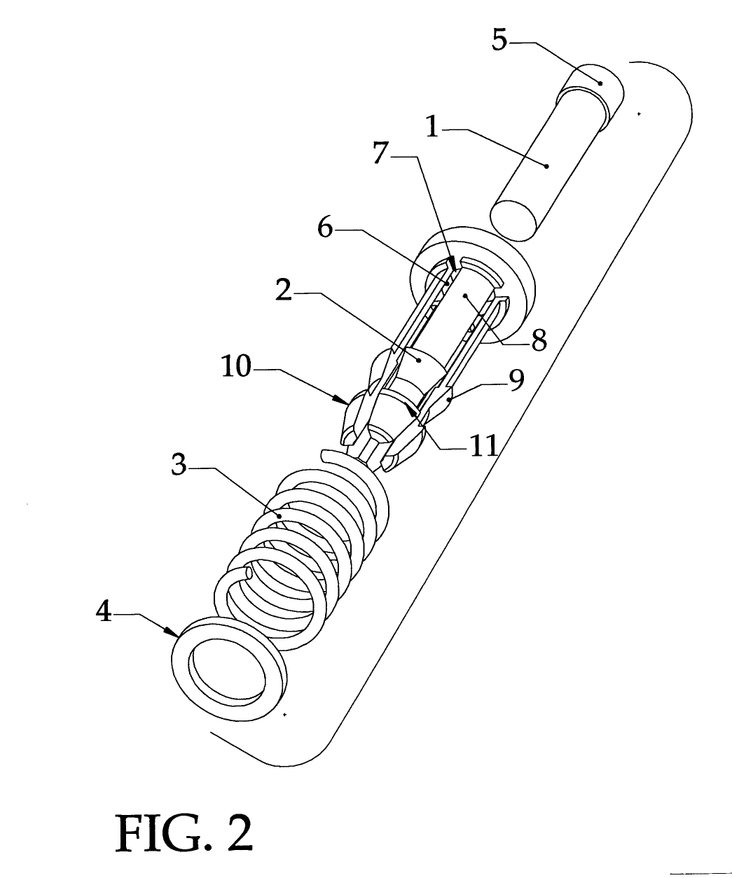

FIG. 2 is a perspective view of the Flexible Flanged Dowel Pin Device shown in FIG. 1.

FIG. 3 is a perspective view of the Flexible Flanged Dowel Pin Device shown in FIG. 1.

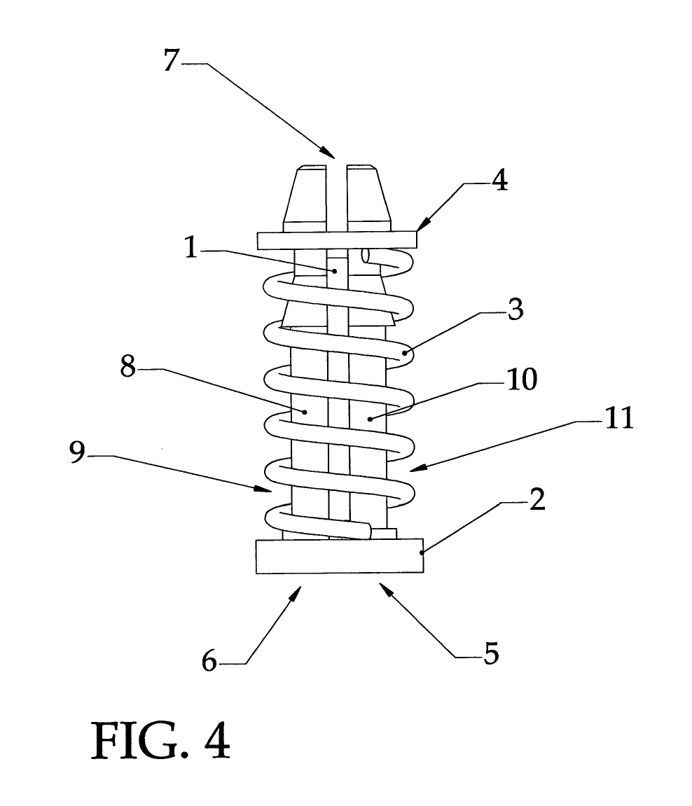

FIG. 4 is a front elevation view of the Flexible Flanged Dowel Pin Device shown in FIG. 1.

FIG. 5 is a section view of the Flexible Flanged Dowel Pin Device shown in FIG. 1.

What is claimed is:

1. What I claim as my invention is a flexible flanged dowel pin device for the purpose of retaining and/or locating one or more suitable pieces of material and or components, comprising but not limited to a flexible flanged dowel pin with one or more axial slots from tip inward some distance sufficient for the purpose of allowing radial spring action when force is applied to either the outward face of the initial barb or subsequent barb or ramp feature, a spring for the purpose of applying force between flexible flanged dowel pin and said material and/or component, a feature and/or washer to translate outward spring force and to convert inward forces to radial forces sufficient to produce radial spring action in flexible flanged dowel pin and a fixable locking pin for the purpose of preventing inward radial movement of the flexible flanged dowel pin tines.

2. The flexible flanged dowel pin device of claim 1 wherein the flange of flexible flanged dowel pin offers sufficient resilience of material and adequate geometry to exert a force equal or greater than that of before mentioned spring.

3. The flexible flanged dowel pin device of claim 1 wherein the flexible flanged dowel pin has an axial hole of sufficient diameter to allow both radial movement of tines when unobstructed by locking pin and to allow the locking pin to fit within it.

4. The flexible flanged dowel pin device of claim 1 and the axial hole of claim 3 wherein said hole has features and/or threads for fixing locking pin.

5. The flexible flanged dowel pin device of claim 1 wherein locking pin has both an outer diameter or geometry suitable for preventing radial movement of tines sufficient to release retained material and a mating feature and/or threads suitable for fixing to the flexible flanged dowel pin.

6. The flexible flanged dowel pin device of claim 1 wherein the spring has a inner diameter or geometry greater than that of the outer diameter or geometry of flexible flanged dowel pin's initial barb, subsequent barb or ramp feature and length sufficient to span the distance between flexible flanged dowel pin's flange and underside of initial barb.

7. The flexible flanged dowel pin device of claim 1 wherein the spring has an outer diameter or feature which prevents it from moving outward past both the before mentioned feature and or washer and the flange of the flexible flanged dowel pin.

8. The flexible flanged dowel pin device of claim 1 wherein the feature and or washer has an inner diameter or geometry greater than the outer diameter or geometry of the initial barb and less than the outer geometry of the subsequent barb or ramp feature of flexible flanged dowel pin when axial members are compressed.

9. The flexible flanged dowel pin device of claim 1 wherein the feature and or washer has an inner diameter or geometry less than the outer diameter or geometry of initial barb of flexible flanged dowel pin when axial members are not compressed.

10. The flexible flanged dowel pin device of claim 1 wherein the spring exerts an outward or “clamping” force greater than the inward force of said material or component sufficient to locate and or retain material between itself and initial slotted barb of flexible flanged dowel pin.
